(19) United States
(12) Patent Application Publication
(10) Pub. No.: US 2006/0124661 A1
(43) Pub. Date: Jun. 15, 2006

(54) Gas pin valve with safety features

(76) Inventor: Thomas S. Siimes, Windsor (CA)

Correspondence Address: CARLSON, GASKEY & OLDS, P.C., 400 WEST MAPLE ROAD, SUITE 350, BIRMINGHAM, MI, 48009, US

(21) Appl. No.: 11/297,176

(22) Filed: Dec. 8, 2005

Related U.S. Application Data
(60) Provisional application No. 60/635,129, filed on Dec. 10, 2004.

(51) Int. Cl. B67D 5/00

(52) U.S. Cl. 222/3

(57) ABSTRACT

A pin valve assembly includes a discharge opening and groove within a threaded body portion providing for the escape of pressurized gases contained within a cylinder prior to the pin valve becoming unthreaded from the cylinder. The valve includes a threaded portion that is assembled and threaded into the cylinder. The threaded portion includes a discharge opening and a groove. As the pin valve is unthreaded, the groove and discharge opening communicate pressurized material against a seal. Once a pressure on the seal is reduced to a desired level, gas is communicated from the cylinder and exhausted past the seal.

### REFERENCE TO RELATED APPLICATION

This application claims priority to U.S. Provisional Application No. 60/635,129 that was filed on Dec. 10, 2004.

### BACKGROUND OF THE INVENTION

This application relates to a gas pin valve for a gas cylinder and specifically to a gas pin valve for a gas cylinder including features that allow safe removal of the valve from a pressurized cylinder.

Typically, a gas cylinder is filled with a liquid or gas under a desired pressure. The gas cylinder is designed to withstand specific pressures and to deliver the gas and liquid at pressure to specific devices. Commonly, devices such as paintball guns or fire extinguishers use the pressurized gas within the cylinder to propel a paintball in the case of the paintball gun, or a fire suppression chemical in the case of a fire extinguisher. In any device, it is desired to maintain the gas or liquid within the cylinder at a given pressure until use. It is known to use a pin-type valve threaded into the outlet of the gas cylinder to control the outlet of gas pressure from the cylinder.

The pin valve is threaded into the outlet of the gas cylinder and includes a threaded member having an inlet hole. When it is desired to release pressure from the cylinder, a pin extending from the piston through the opening is pushed downward. By pushing downward on the pin, the piston is lifted off the seal and gas pressure is allowed to escape through the inlet. The pin portion of the piston extends through the opening and is of a diameter smaller than the opening to allow gas pressure to be released from the gas cylinder.

In some instances an inexperienced operator may attempt to remove the pin valve with the cylinder pressurized. As the pin valve is unthreaded from the cylinder, the gas pressure within the cylinder continues to act on the pin valve. In some instances, a seal is initially blown allowing the escape of pressurized gas within the cylinder. This is a desired occurrence. However, depending on the substance stored within the cylinder, the gas escaping may not reduce the pressure in the cylinder enough to prevent a dangerous condition. In some instances, the quick release of carbon dioxide will form solid materials that clog the threads and prevent the escape of gas through the threads. Further, unthreading can result in an abrupt and undesirable release of the pin valve from the cylinder.

Accordingly, it is desirable to develop and design a pin valve that can be safely removed from a pressurized cylinder without producing a sudden and abrupt release of the pin valve.

### SUMMARY OF THE INVENTION

This invention is a pin valve assembly including a discharge opening and groove within a threaded body portion providing for the escape of pressurized gases contained within a cylinder prior to the pin valve becoming unthreaded from a gas cylinder.

An example pin valve assembly according to this invention includes a spring biasing a piston against a seal to seal a gas cylinder. The spring compresses a length determined by a distance between the insert and the plunger. The valve includes a threaded portion that is assembled and threaded into the gas cylinder.

The threaded portion includes a discharge opening and a groove. As the pin valve is unthreaded, the groove and discharge opening communicate pressurized material against a seal. Once a pressure on the seal is reduced to a desired level, gas is communicated from the cylinder and exhausted past the seal such that any gas within the cylinder is exhausted. The gas within the cylinder is exhausted prior to a significant number of threads becoming disengaged, such that the pin valve remains secured to the cylinder during the exhaust of gases.

Accordingly, a valve assembly according to this invention can be safely removed from a pressurized cylinder without producing a sudden and abrupt release of the valve assembly.

These and other features of the present invention can be best understood from the following specification and drawings, the following of which is a brief description.

### BRIEF DESCRIPTION OF THE DRAWINGS

FIG. 1 is a cross-sectional view of an example gas cylinder assembly according to this invention.

FIG. 2A is a side view of an example valve assembly according to this invention.

FIG. 2B is a top view of the example valve assembly shown in FIG. 2A.

FIG. 3A is a side view of an example valve assembly according to this invention.

FIG. 3B is a top view of the example valve assembly shown in FIG. 2A.

FIG. 4A is a side view of an example valve assembly according to this invention.

FIG. 4B is a top view of the example valve assembly shown in FIG. 2A.

### DETAILED DESCRIPTION OF THE PREFERRED EMBODIMENT

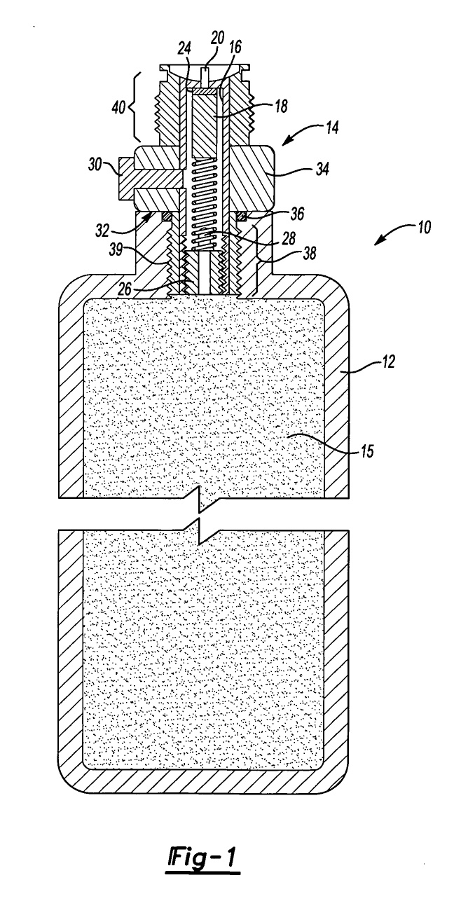

Referring to FIG. 1, a gas cylinder assembly 10 includes a gas cylinder 12 for holding a pressurized material such as a gas or liquid. The cylinder 12 includes an opening to which is threaded a valve assembly 14. The valve assembly 14 includes a slotted discharge opening 28 within a first threaded portion 38. The threaded portion 38 threadingly engages internal threads 39 of the gas cylinder 12. A seal 36 is disposed between the gas cylinder 12 and a sealing face 32 of the valve assembly 14. A tightened valve assembly 14 exerts a pressure on the seal 36 that prevents the exhaust of pressurized gases 15 within the cylinder 12.

Removal of the valve assembly 14 with pressure within the gas cylinder 12 will initial blow the seal 36 and release some pressurized gas. However, the pressurized gas within the cylinder 12 will only be released as it flows past the mating threads 39,38 between the valve assembly 14 and of the cylinder 12. In prior art valves, the leak path for gas past the threaded interface is not sufficient to provide a quick enough exhausting of gases 15 to reduce pressure within the cylinder 12 below an acceptable level. The valve assembly 14 of this invention includes the discharge opening 28. Further unthreading of the valve assembly 14 reduces pressure on the seal 36 and exposes the discharge opening 28 to the contents of the cylinder 12 and thereby provides a release of pressure within the cylinder.

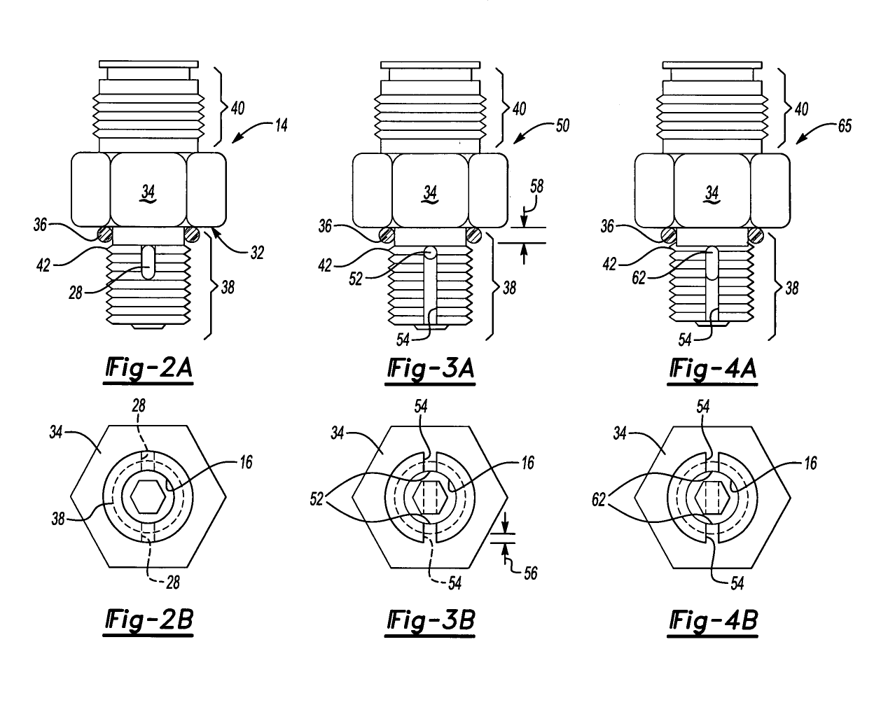

Referring now also to FIGS. 2A and 2B, with continuing reference to FIG. 1, the release of pressure from within the cylinder 12 occurs due to communication of the gas 15 within the cylinder 12 by way of the discharge opening 28. Unthreading of the valve assembly 14 causes a release or pressure on the seal 36. Once pressure on the seal 36 is released below a desired level, gas 15 within the cylinder 12 is exhausted.

The exhaust of the gas 15 from the cylinder 12 occurs also due to the position of the discharge opening 28. The discharge opening 28 is positioned proximate to a first thread 42 such that there remains sufficient thread to hold the valve assembly 14 in place on the cylinder 12 during the exhaust of pressurized gas 15 from the cylinder 12. The discharge opening 28 provides for the release of gas 15 from the cylinder 12 prior to a condition where pressure from within the cylinder 12 can overcome the threaded interface of the threads 38 and 39.

Referring now to FIGS. 3A and 3B with continuing reference to FIG. 1, another valve assembly 50 according to this invention includes a discharge opening 52 disposed within a groove 54. Gas from the cylinder 12 is communicated through the discharge 52 and also through the groove 54 to the seal 36. Initial unthreading of the valve assembly 50 causes a release of seal pressure that provides for gas 15 to be exhausted from the cylinder 12 prior to the valve assembly 50 becoming unthreaded to a point that an undesirable pressure is maintained within the cylinder 12 that can cause an uncontrolled release of the valve assembly 50.

The groove 54 is disposed at a depth 56 that is at least equal to a width 58 of the seal 36. This sizing of the groove 54 provides a desired flow of gas 12 from the cylinder 12 in a desired time to expel gas 15 prior to the complete unthreading of the valve assembly 14.

Referring to FIGS. 4A and 4B, another valve assembly 65 according to this invention includes a slotted discharge 62 that is disposed within the groove 54 within the threaded portion 38. The increased opening area provided by the slotted discharge opening 62 provides for a faster release of gas 15 to further prevent undesirable pressure levels from remaining within the cylinder 12 while removing the valve assembly 26. The increased opening area provided by the combination of the slotted opening 62 and the groove 54 is desirable for pressurized materials such as carbon dioxide gases that may form solid structures in smaller openings, and within threads, thereby reducing the amount of gas that can be released.

The size of the discharge opening 62 either alone or in combination with the groove 54 is determined to exhaust gases from the cylinder 12 to at least decrease a pressure within the cylinder 12 to a desired level that cannot result in dislodgement of the valve assembly 14.

As appreciated, different numbers and orientations of slots and openings within the threaded portion of the valve are within the contemplation of this invention. The specific configuration may be determined according to the specific pressures and material properties of the pressurized substance contained within a cylinder.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. For that reason, the following claims should be studied to determine the true scope and content of this invention.

What is claimed is:

1. A gas cylinder assembly comprising:
a gas cylinder defining a chamber for storing a pressurized substance; and
a valve assembly attached to the gas cylinder for regulating release of the pressurized substance through an outlet, said valve assembly including a threaded portion engaged to the gas cylinder and discharge opening within the threaded portion for exhausting the pressure substance from the chamber responsive to movement of the valve assembly toward a partial removal of the valve assembly from the gas cylinder.

2. The assembly as recited in claim 1, including a seal disposed between a portion of the valve assembly and the gas cylinder, the seal being under a desired pressure when the valve assembly is assembled to the gas cylinder, wherein the discharge opening exhausts a pressurized substance from the chamber responsive to a decrease of the desired pressure on the seal below a desired amount.

3. The assembly as recited in claim 1, wherein the discharge opening communicates the pressurized substance with a seal disposed between the valve assembly and the gas cylinder.

4. The assembly as recited in claim 3, wherein the threaded portion includes a groove and the discharge opening is disposed within the groove.

5. The assembly as recited in claim 4, wherein the groove includes a depth equal to a width of the seal.

6. The assembly as recited in claim 1, wherein the discharge opening includes an opening area that is at least double an area of the outlet.

7. The assembly as recited in claim 1, wherein the discharge opening is disposed within the threaded portion adjacent a first thread closest to the seal.

8. The assembly as recited in claim 1, wherein said opening comprises a slot.

9. The assembly as recited in claim 1, wherein said valve assembly includes a pressure relief device for exhausting pressurized material within the chamber responsive to a pressure within the chamber exceeding a desired pressure.

10. A valve assembly comprising:
a housing defining a first bore comprising an inlet and an outlet;
a piston movable within said bore between a closed position blocking the outlet and an open position not blocking the outlet;
a threaded portion for fastening said housing to a pressure vessel; and
a discharge opening disposed within said threaded portion for exhausting pressurized material from said pressure vessel responsive to a partial unthreading of the valve assembly from the pressure vessel.

11. The assembly as recited in claim 10 including a seal for sealing between the housing and the pressure vessel, wherein the opening communicates pressurized material within the pressure vessel to the seal.

12. The assembly as recited in claim 10, wherein the discharge opening comprises an opening having an area determined to exhaust a desired amount of pressurized material within a desired time.

13. The assembly as recited in claim 10, wherein the discharge opening comprises an area equal to or greater than an area of the outlet.

14. The assembly as recited in claim 10, wherein said threaded portion includes a groove disposed transverse to threads of the threaded portion, and said discharge opening is disposed within said groove.

15. The assembly as recited in claim 10, wherein the discharge opening comprises an elongated slot.

16. The assembly as recited in claim 10, including a pressure relief device for exhausting pressurized material from the pressure vessel responsive to a pressure above a desired threshold value.
